(19) United States
(12) Patent Application Publication
(10) Pub. No.: US 2013/0113680 A1
(43) Pub. Date: May 9, 2013

(54) ANTENNA CONCEALMENT STRUCTURES INCORPORATING FABRIC CONCEALMENT SHELLS

(71) Applicant: STEALTH Concealment Solutions, Inc., North Charleston, SC (US)

(72) Inventors: Joseph J. NEMETH, III, Charleston, SC (US); Sean MCLERNON, John's Island, SC (US)

(73) Assignee: STEALTH CONCEALMENT SOLUTIONS, INC., North Charleston, SC (US)

(21) Appl. No.: 13/672,412

(22) Filed: Nov. 8, 2012

Related U.S. Application Data
(60) Provisional application No. 61/557,096, filed on Nov. 8, 2011.

(51) Int. Cl. H01Q 1/42

(52) U.S. Cl. CPC H01Q 1/42
USPC 343/872

(57) ABSTRACT

A system for enclosing antenna structures such that they blend in with the architecture and scenery of the location in which they are placed is disclosed. A structural support frame is constructed to match a specific desired architectural appearance. The structural support frame may be made up of framing elements, and may include antenna elements attached to the framing elements. The structural support may also surround antenna elements without being attached to the antenna elements. A flexible fabric material is attached to the support structure to form an outer concealment shell. The flexible fabric material may be configured to match a specific desired architectural or patterned appearance. The flexible fabric may be made from a material which is strong and weather resistant, but which causes little RF interference.

### DESCRIPTION OF RELATED APPLICATIONS

This application claims priority to U.S. Provisional Patent Application No. 61/557,096, filed on Nov. 8, 2011, the contents of which are incorporated herein by reference in their entirety.

### FIELD OF THE INVENTION

The present invention relates to the art of antenna enclosures, and, in particular, to the art of antenna enclosures that blend in with the architecture and scenery of the location in which they are located.

### BACKGROUND OF THE INVENTION

The proliferation of satellite dishes for home use and antenna towers for cellular telephones has, according to many people, had an adverse impact on the landscapes of the areas in which these items are built. Accordingly, many locales place restrictions on the construction of satellite dishes and cellular antenna towers. Similarly, even in those places where there are no local ordinances prohibiting or restricting their use, the private owner of a location most suitable for the placement of a cellular antenna or satellite dish, e.g., the owner of the tallest building in the area, may deny placement of the cellular antenna or satellite dish at that location because it would detract from the aesthetic value of the location. Accordingly, methods by which satellite dishes, cellular antenna towers, and other types of antennas can be unobtrusively implemented have been developed.

For example, U.S. Pat. No. 4,710,778 to Radov illustrates concealing a small satellite dish in a hole in a roof of a home. A bulging dome-like canopy is used to protect the dish while allowing the dish to have some degree of movement.

U.S. Pat. No. 5,349,362 to Forbes et al. illustrates concealing an antenna in a vent pipe of a building. Finally, U.S. Pat. No. 5,375,353 to Hulse illustrates the use of a weather resistant fabric, such as vinyl covered polyester cloth, with an outer coating of polyvinyl chloride (PVC), to cover the steel girders of various portions of an antenna tower (Hulse does not illustrate the antenna, itself).

Applicant's also have a prior patent application, PCT WO 98/53522 which discloses a concealment structure for making an antenna appear like a flag pole or light pole.

All of the prior art approaches to date utilize specially designed, rigid materials for each installation. These rigid materials can be difficult to assemble, and must typically be custom designed for each installation. Custom designs make it difficult for finding replacement parts for repair of existing concealment installations, and make it difficult for the owner to change the appearance of an installation after the fact.

Thus, while each of the above approaches may be suitable for their intended uses, there is still room for improvement within the art of antenna concealment.

### SUMMARY OF THE INVENTION

To achieve the above-described and other aims, the present invention provides a shell and an associated support structure for enclosing an antenna mounted on an elongated member, where the shell is substantially transparent to electromagnetic waves. Further, the shell is made of fabric and the support structure allows the shell to be moved and/or removed to provide access to the underlying antenna, or to be changed to achieve a different aesthetic appearance.

As will be readily appreciated by one skilled in the art, the shell can be adapted to take on a variety of different appearances, preferably one that is in harmony with the surrounding architecture or locale.

Additional embodiments of the invention, as described below, include non-pole concealment structures which comprise a frame and a fabric enclosure, wherein the frame and the fabric enclosure form a shell around antenna elements which is substantially transparent to electromagnetic waves. These non-pole concealment structures include additional framing elements that connect together to form a desired shape. For example, the non-pole concealment structures could include a frame and fabric shell in the shape of a clock tower or chimney for concealed placement on the roof of a building.

The various aspects and embodiments of the inventions herein having been thus described and summarize, preferred embodiments thereof will now be described in detail with reference to various drawings.

### BRIEF DESCRIPTION OF THE DRAWINGS

FIG. 1, constituting the prior art as disclosed in Applicant's prior patent application WO98/53522, is a perspective view of an elongated member carrying two antennas and means for supporting a shell according to the prior art.

FIG. 2, constituting the prior art as disclosed in Applicant's prior patent application WO98/53522, is a perspective view showing the shell resting on a support plate and enclosing a single antenna according to the prior art.

FIG. 3, constituting the prior art as disclosed in Applicant's prior patent application WO98/53522, is a perspective view showing a screw used to fasten a shell and a support plate to one another according to the prior art.

FIG. 4, constituting the prior art as disclosed in Applicant's prior patent application WO98/53522, is a cross sectional view of FIG. 3 taken along line IV and looking in the direction of the arrow showing the relationship between the screw, shell, and support plate according to the prior art.

FIG. 5, constituting the prior art as disclosed in Applicant's prior patent application WO98/53522, is a perspective view showing the shell slid upward and held by a second support plate thereby revealing the antenna according to the prior art.

FIG. 6, constituting the prior art as disclosed in Applicant's prior patent application WO98/53522, is a plan view illustrating a flag pole containing antennas enclosed by shells according to the prior art.

FIG. 7, constituting the prior art as disclosed in Applicant's prior patent application WO98/53522, is a plan view illustrating a light pole containing antennas enclosed by shells and housing according to the prior art.

FIG. 8, constituting the prior art as disclosed in Applicant's prior patent application WO98/53522, is a perspective view illustrating one method for locking a shell to a support plate according to the prior art.

FIG. 9A is a plan view and FIG. 9B is a perspective view of Applicant's present invention without the external concealment fabric cover, as described below.

FIG. 10 is a plan view illustrating another prior art method for concealing an antenna.

FIG. 11 is a plan view illustrating Applicant's present invention with the external concealment fabric cover, as described below.

FIG. 12A is a perspective view illustrating antennas within an extended support frame structure, that can be modified to any shape, without the external fabric cover.

FIG. 12B is a plan view illustrating an embodiment with an extended support frame structure and external fabric cover designed as a clock tower.

### DETAILED DESCRIPTION OF THE PRIOR ART DEVICE

This section comprises a detailed description regarding Applicant's prior technology as reflected in PCT application publication no. WO98/53522, which was published Nov. 26, 1998, and which is generally reflective of the state of the art. Such is being described herein in order for one skilled in the art to more fully understand the improvements to the present state of the art provided by Applicant's present invention, which present invention will be described in the next section, titled “DETAILED DESCRIPTION OF THE PRESENT INVENTION.”

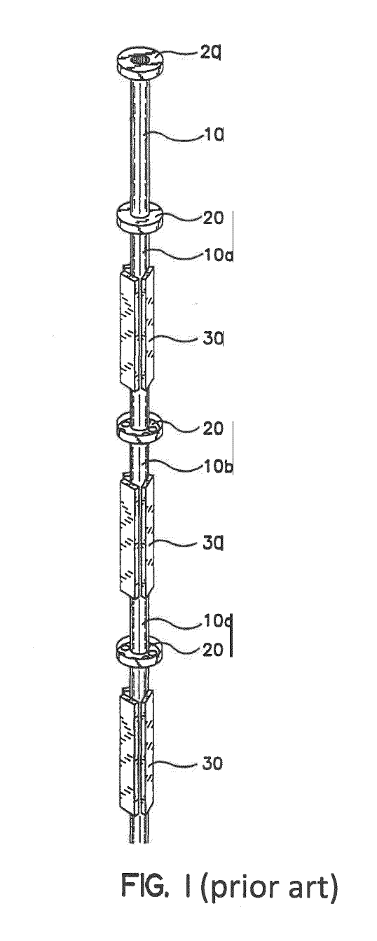

FIG. 1 depicts the invention of WO98/53522, showing a set of antennas carried on an elongate member, without the shell.

Elongated member 10 is shown carrying three sets of antennas 30. While three sets of antennas are illustrated, in practice, the number of antenna sets that can be deployed is limited only by the length of elongated member 10 and the size of the antennas. Antennas 30 are usually rotatable about elongated member 10 allowing the antennas to be directionally tuned. Alternatively, elongated member 10 can be segmented with each segment 10a, 10b, and 10c being rotatable to tune the antennas. Spaced along elongated member 10 are plates 20 having a diameter large enough to support a shell that will enclose antennas 30. The type or shape of device chosen to support the shell is not critical to the invention as long as it will support a shell that encloses the antenna.

FIG. 2 shows the support structure of the invention of WO98/53522 with the shell 40 in place. Shell 40 rests on plate 20 and is confined in place by lip 20a. Since shell 40 isolates antenna 30 from the outside environment, it must be made of a material that is substantially transparent to electromagnetic waves. Furthermore, shell 40 should be made of a material that can be treated to look like the surrounding architecture.

According to WO98/53522, shell 40 is typically made from conventional ABS (acrylonitrile butadiene styrene) made by a variety of manufacturers (such as Spartech Plastics). Alternative materials taught by WO98/53522 for shell 40 include Duraform Architectural Telecommunications Panels made by Vacuform Industries, Inc., of Columbus, Ohio, conventional vinyl laminated polyester made by numerous manufacturers, Sentra form of PVC, and, least preferably, RF-friendly fiberglass. Essentially, the choice of material used for shell 40 is dictated by the material strength required and the dielectric constant necessary to pass electromagnetic waves for a given application. ABS is often preferred because it has been found to be strong, substantially transparent to most electromagnetic waves and amenable to treatment such as painting, thermoforming, or epoxying.

Nowhere does WO98/53522 describe or suggest that the outer shell can be made of a radio transparent fabric made to fit over supports formed in the antenna body, as will be described below in the section “DETAILED DESCRIPTION OF THE PRESENT INVENTION,” nor is Applicant aware of any prior products using such.

WO98/53522 teaches that shell 40 is treated to look like either the surrounding architecture or whatever the enclosure is to have the appearance of, such as through painting shell 40. When selecting the actual materials for use in making shell 40, it was desired that the material be substantially transparent to electromagnetic waves to be received or discharged by the antenna to be enclosed, i.e., allows them to pass through the material with only minimal interference and signal degradation.

WO98/53522 teaches that additional security for the antenna may be desired. FIGS. 3 and 4 of WO98/53522 illustrate an embodiment where shell 40 and lip 20a have holes in alignment through which screw 50 can be inserted to fasten plate 20 and shell 40 to one another. The type and size of screw used can be chosen based on the size of the structure and the degree of security desired. Alternatives to using a screw to fasten shell 40 to lip 20a include a bolt, pin, or other suitable means.

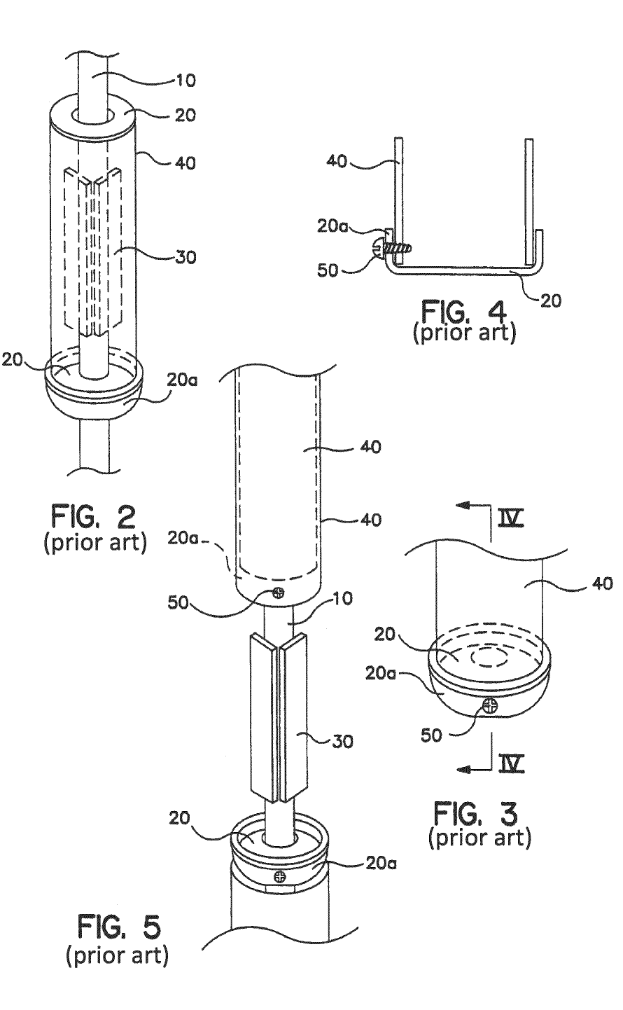

In addition to providing security, screw 50 can be used to support shell 40 when working on antenna 30. As shown in FIG. 5, screw 50 can be removed so that shell 40 can be slid upward to reveal antenna 30. Because shell 40 could be heavy depending on its size, it is useful to align shell 40 with a second plate 20 and insert screw 50 through the hole in lip 20a to support shell 40 while maintenance is performed on antenna 30. Since several shells 40 are often used in an antenna enclosure, the shells should be tapered so that the structure continually narrows in one direction. By tapering the shells, it allows one shell to easily slide over another when accessing an underlying antenna.

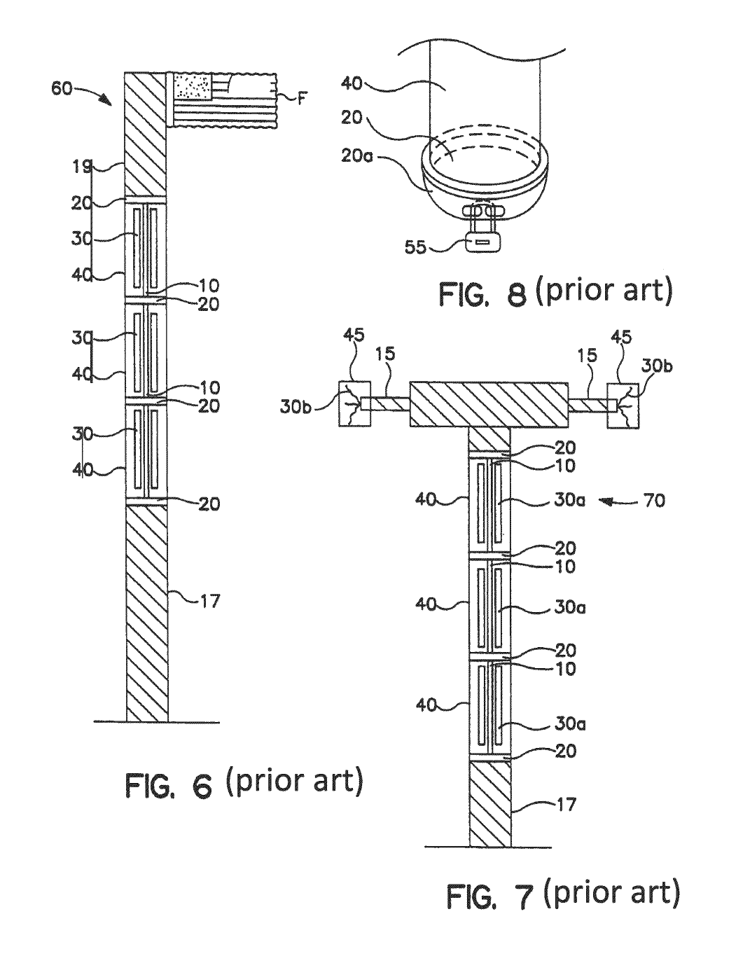

Finally, FIGS. 6 and 7, taken from WO98/53522, show two separate applications incorporating the prior art technology: a flag pole and a light pole. Referring now to FIG. 6, contained within flag pole 60 flying flag F are three separate antennas 30 mounted on elongated member 10. Antennas 30 are either rotatable about elongated member 10 or elongated member 10 is segmented to provide rotation for tuning the antennas as discussed above. The number of antennas deployed in a particular application will depend on the length of elongated member 10 and the size of the antennas. Plates 20 are mounted on elongated member 10 to support shells 40. Shells 40 can be slid upward to provide access to the underlying antennas. In the case of a flag pole, it is relatively simple to paint shells 40 the same color as the remainder of the pole so that the casual observer would be oblivious that the pole is serving as an antenna tower. Note that in this application, the three separate antennas could be owned by three different organizations. To ensure that one organization's antenna is not accessed by a competitor, the screw discussed above could be replaced by a more elaborate locking mechanism shown in FIG. 8. In that example, lip 20a and shell 40 have two holes designed to receive a common padlock 55. A screw may still be used to temporarily lock shell 40 to plate 20 when shell 40 is slid upward for antenna maintenance.

To provide a suitable height for antennas 30, elongated member 10 is mounted on top of monopole 17. Monopole 17 may be many feet high when flag pole 60 is mounted on the ground or may be a simple base piece when flag pole 60 is mounted atop a building or other structure.

Lastly, WO 98/53522 teaches that it is preferable to mount a top portion 19 on top of elongated member 10 to carry flag F. By mounting flag F on top portion 19, the flag is away from antennas 30 and will therefore not interfere with signal transmission or reception. Furthermore, flag F should be positioned high enough on top portion 19 so as not to interfere with shell 40 when it is slid upward for antenna maintenance.

FIG. 7 from WO98/53522 illustrates a light pole 70 that can be used to enclose antennas. Similar to the flag pole discussed above, light pole 70 includes an elongated member 10 mounted on top of monopole 17. Elongated member 10 provides a vertical support on which antennas 30a are attached. Again, antennas 30 are rotatable for tuning purposes. Plates 20 are used to support and lock shells 40 in the same manner as discussed above. In addition, light pole 70 includes a horizontal member 15 that supports antennas 30b. Antenna 30b is often a larger antenna used for cellular service. Instead of a shell, housing 45 is used to enclose antennas 30b; however, housing 45 is made from the same materials discussed above for shell 40.

Alternatively, WO 98/53522 teaches that actual lights could be used in addition to or in place of antennas 30b so that light pole 70 does give off light. Because shells 40 and housing 45 can be made to have the appearance of a shiny metallic pole, light pole 70 should blend in with other light poles regardless of whether it ever provides light.

While only a flag and light pole are illustrated, WO98/53522 teaches that numerous other structures could be used for camouflaging an antenna, including, for example, telephone poles, silos, water towers, billboards, or artificial trees.

### DETAILED DESCRIPTION OF THE PRESENT INVENTION

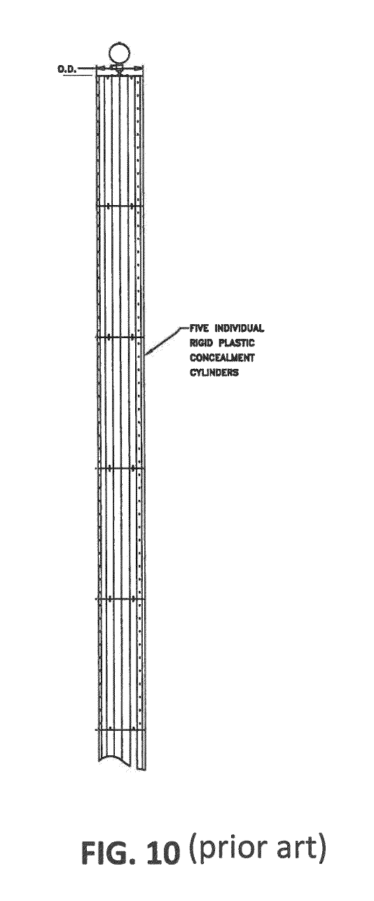

Prior art antenna concealment products commonly employ an outer, radio-transparent shell of some sort, which is constructed of rigid exterior façade panels, typically of plastic, foam, or fiberglass construction as discussed above. These are supported by a structural frame, and the exterior of the panels are generally treated to match a specific desired architectural appearance. An example of this is depicted in FIG. 10, as well as the prior-described FIG. 1 through FIG. 8.

The flexible fabric described herein utilizes a flexible fabric material, such as vinyl-coated polyester flexible fabric or other similar fabric material, for the purpose of forming the outer concealment shell for the antennas instead of a hard shell material. Suitable flexible fabric materials include any that are strong and weather resistant, but which cause very little RF interference. The fabric may be attached to the support structure via bolts, straps, magnets, or some combination thereof. The concealment shell may conceal the entire support structure and antenna, or may conceal only a portion of the support structure and/or antenna. The concealment shell may camouflage the support structure and antenna within the surrounding architecture or locale. For example, the concealment shell may take the form of a lamp post which camouflages the support structure and antenna along a street. As another example, the concealment shell may have a surface with a brick design included thereon to camouflage the support structure and antenna as additional architecture on an existing building.

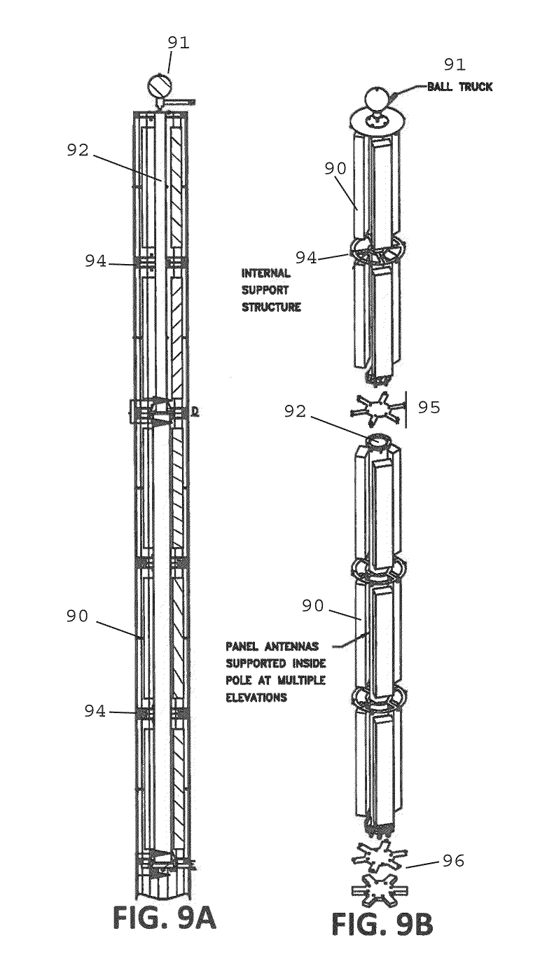

FIG. 9A and FIG. 9B are plan and perspective views, respectively, of a typical antenna support structure that will be enclosed by a flexible fabric enclosure according to Applicant's present invention. The antenna support structure may be formed from fiberglass reinforced plastic (“FRP”), steel, or aluminum, and is mounted either to an existing building or structure, or to a foundation in the ground. Its purpose is to support the one or more antennas and the concealment cover. As shown in these FIGS. 9A and 9B, the structure may be configured so as to mimic a cylindrical steel flag pole. This structure includes an elongate member 92, which forms a central pole that carries sets of antenna 90. When configured to mimic a steel flag pole, the support structure at the top bears a ball truck 91 for supporting a flag, and also includes wheel shaped discs 94, 95, 96 (or other suitable supports) at various distances along its length to serve as a frame over which the flexible fabric shell cover will be fitted. The wheel shaped may be attached at regular intervals along the length of the pole. Depending upon the particular outer shape desired, these framing elements attached to the support pole can of course take other shapes as necessary to provide the outer fabric concealment shell with suitable shape. According to some embodiments, the framing elements may be adapted to allow the shell to slide along an axis defined by the elongated member, whereby the underlying antenna is revealed. The framing elements may be directly attached to the support pole, or may surround the support pole and antenna elements without being directly attached thereto. For example, the framing elements may be attached to the same ground or building structure to which the antenna is attached, and create a frame such that the outer fabric substantially surrounds and conceals antenna elements.

As such, the flexible fabric constitutes the exterior façade of an antenna concealment product. This flexible fabric exterior covers the structural frame of the underlying antenna, and one or more antenna elements attached along its length. The structural frame of the underlying antenna may include a frame of steel, fiberglass FRP, aluminum, or other like materials.

The flexible fabric material can painted or otherwise coated to match a specific desired color or other architectural appearance, such as a brick or stone pattern. As will be readily appreciated by one skilled in the art, because the outer concealment shell is fabric, it offers the benefit of being readily replaceable with new covers to provide new looks and is relatively inexpensive to manufacture. Designs can be readily painted, printed, or otherwise provided on the exterior of the fabric shell to provide the concealment design desired for a particular application. Further, the flexible fabric will greatly reduce fabrication and installation time required. Additionally, it is lighter than a traditional rigid concealment panel, reducing loading on an existing structure, and its flexible nature reduces the space required for shipping.

One of ordinary skill in the art will readily appreciate that the present invention is advantageous because it has less parts than the conventional rigid enclosure systems. Using one currently popular pole product as an example, FIG. 10 depicts the pole product of the prior art which entails using a plurality of plastic or fiberglass cylinders that are stacked on one another in typical 10′ heights to achieve the required number of sections (typically 3-7). Stacking and attaching such cylinders together requires significant effort, as each can typically have up to twelve attachment points. These multiple cylinders of the prior art are replaced by a single fabric “tube” in Applicant's present invention. In other embodiments, the fabric “tube” may be made by attaching multiple fabric sections to the support frame. Using flexible fabric as the exterior of the concealment structure provides several benefits over the prior art rigid materials. The materials in the flexible fabric exterior covers are of lower cost, are easier to install, and the ability to use a one piece design makes for less chance of a mistake or interference problem between the concealment exterior and the interior support structure.

Additionally, the fabric can be formed of stretchable materials to enhance outer appearance of the installation and/or to facilitate enclosure of irregular objects.

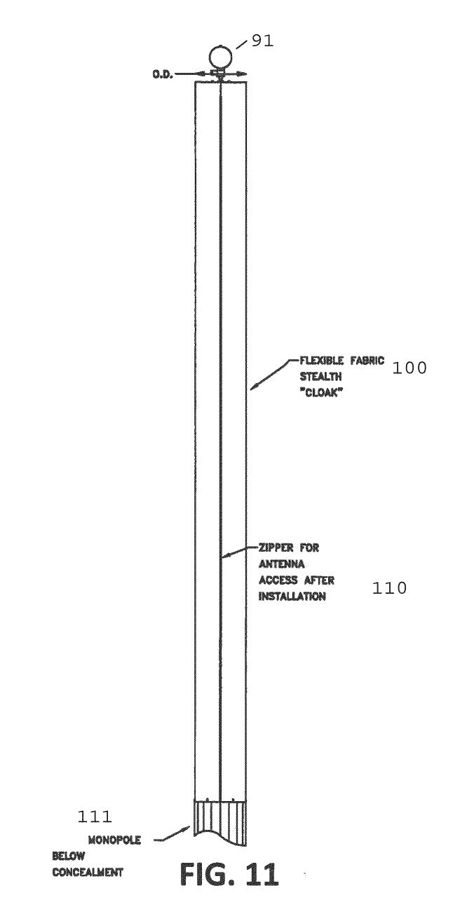

The flexible fabric enclosure utilized in embodiments of the present invention can be fabricated and installed as shown in FIG. 11 to cover, for example, the entire length of a monopole including the top antenna concealment area, which would eliminate the need to paint the monopole (the fabric is coated to desired color). Alternatively, the flexible fabric may be configured to just cover the portion containing the antenna. As seen in FIG. 11, the structure may include a ball truck 91 at the top for supporting a flag and a monopole 111. As discussed above, the fabric may or may not cover the monopole 111. The support structure may be covered by the flexible fabric 100, which attaches to support structure so as to substantially surround the antenna elements. Optionally, the fabric cover can include an access element 110 for access to the concealed antenna elements and support structure on the interior of the fabric cover. This access element 110 may be a zipper, Velcro®, or other quick-fastening element sewn into the flexible fabric for access to the concealed interior. Further, the fabric enclosures of the present invention can be utilized to replace existing/broken plastic concealment cylinders on existing concealed pole products, which include conventional hard and rigid enclosures.

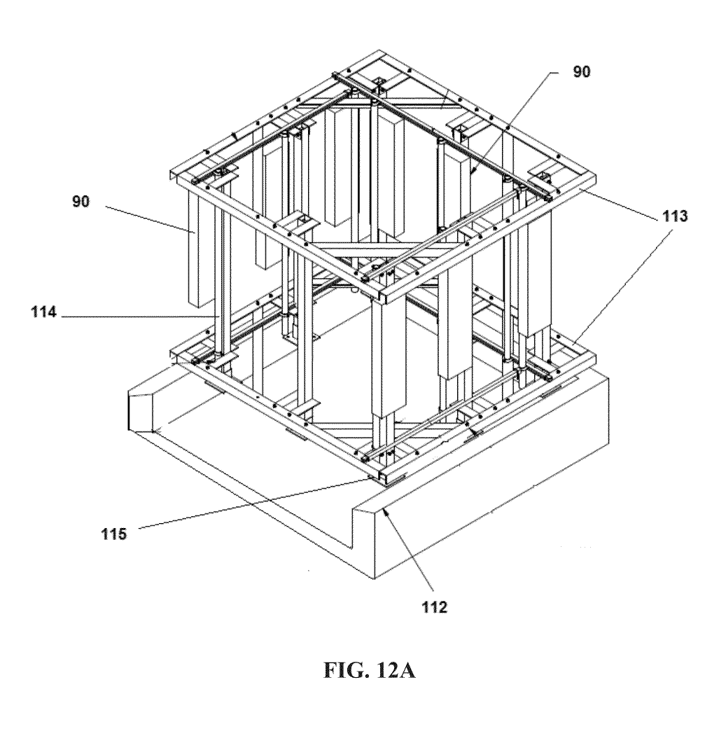

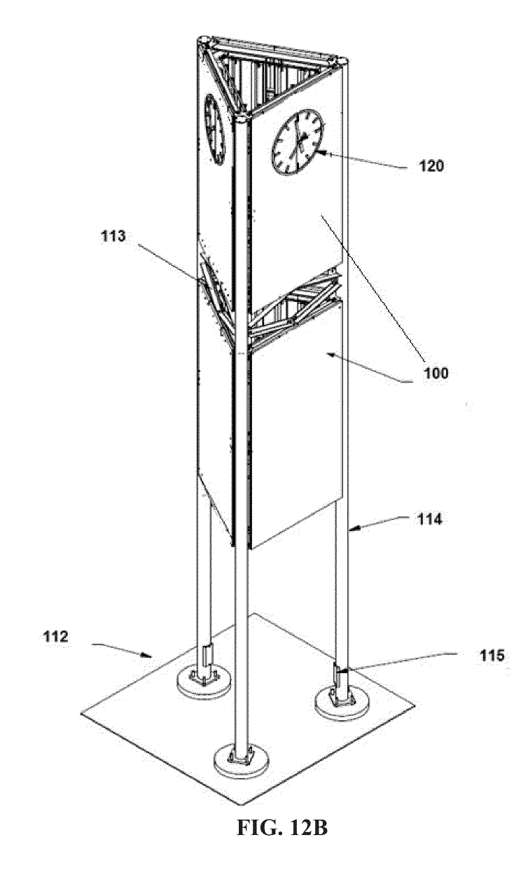

While the antenna concealment products described herein are pole products (flagpoles, lightpoles, banner poles, etc.) as depicted in FIG. 9A, FIG. 9B, and FIG. 11, it should be readily appreciated by one skilled in the art the present invention can readily be extended and adapted to form exterior concealment covers for tower products (clock towers, bell towers, monolithic decorative towers, etc.), rooftop products (screenwalls, chimneys, signs, etc.), and other known antenna concealment products by replacing the rigid exterior shell materials with fabric concealment covers as described herein. As shown in FIG. 12A, the antenna support structure may include additional framing elements 113, 114. The additional framing elements may include horizontal framing elements 113 and vertical framing elements 114. Additionally, the framing elements may have any shape and configuration required to provide the overall desired shape of the support structure. The additional framing element may include, for example, brackets, bolts, pipes, plates, girders, curved support elements, angled support elements, or other construction and framing materials. The sets of antenna 90 may be attached to the horizontal framing elements 113, the vertical framing elements 114, or any other framing elements included in the support structure. As shown in FIG. 12A, the framing elements may include a base element 115 for attachment of the support structure and antennae to an existing structure 112. Alternatively, the sets of antenna may be attached to a separate structure, and the support structure onto which the flexible fabric shell will be attached may substantially surround this separate structure. For example, the framing elements may be attached to the same ground or building structure to which the antenna is attached, and create a frame such that outer fabric substantially surrounds and conceals antenna elements.

As shown in FIG. 12B, the framing elements may be configured to create a support structure in the shape of a clock tower. The support elements may include horizontal support elements 113 and vertical support elements 114. The support structure may include base elements 115 for attachment to an existing structure 112. The support structure may also be directly attached to the ground, or to a baseplate. A flexible fabric cover 100 bearing a design mimicking a clock tower structure may be attached to these framing elements. The flexible fabric cover may have a cutout 120, through which the face of a clock may be seen. In alternative embodiments, cutouts may be included for lights, signs, advertisements or any other display elements of the concealment structure. The flexible fabric cover 100 may include several separate fabric covers attached to and between framing elements, as shown in FIG. 12B. These flexible fabric covers may be attached to any of the framing elements to form the shell, such that the sets of antenna are concealed within the interior of the shell. Alternatively, the flexible fabric cover could be a single piece of fabric, or multiple pieces of fabric connected together, that cover substantially all of the support structure.

The fabric may cover a monopole included at the bottom of the antenna structure to provide attritional height to the antenna structure, or may be located above the monopole. The type or shape of device chosen to support the shell is not critical to the invention as long as it will support a shell that encloses the antenna.

The preferred embodiments having thus been described, those skilled in the art will readily appreciate that various modifications and variations can be made to the above described preferred embodiments without departing from the spirit and scope of the invention. The invention thus will only be limited to the claims as ultimately granted.

1. An antenna enclosure comprising:
an elongated member supporting said antenna;
a shell made from a flexible fabric, said flexible fabric material being substantially transparent to electromagnetic waves and having a surface adapted to conceal the elongated member and antenna; and
a support structure including framing elements for supporting said shell;
whereby said antenna is enclosed by said shell.

2. The antenna enclosure of claim 1, wherein said antenna is rotatably supported by said elongated member.

3. The antenna enclosure of claim 1, wherein said framing elements are adapted to allow said shell to slide along an axis defined by said elongated member, whereby said underlying antenna is revealed.

4. The antenna enclosure of claim 1, wherein the support structure and flexible fabric substantially surround the antenna and elongate member.

5. The antenna enclosure of claim 4, wherein the support structure is attached to the ground area or building structure to which the antenna is attached.

6. The antenna enclosure of claim 1, wherein the support structure is directly attached to the elongated member.

7. The antenna enclosure of claim 1, wherein the support structure substantially surrounds the antenna and elongated member without being directly attached thereto.

8. The antenna enclosure of claim 1, wherein the support structure and flexible fabric shell form a cylindrical structure.

9. The antenna enclosure of claim 8, wherein the cylindrical structure comprises a flag pole structure.

10. The antenna enclosure of claim 9, wherein the support structure bears an element at the top for supporting a flag, and wherein the framing elements comprise disks distributed at various distances along the length of the elongated member to serve as a frame over which the flexible fabric shell is fitted.

11. The antenna enclosure of claim 8, wherein the cylindrical structure comprises a light pole structure.

12. The antenna enclosure of claim 1, wherein the flexible fabric is attached to the support structure by at least one of bolts, straps, magnets, or a combination thereof.

13. The antenna enclosure of claim 1, wherein the flexible fabric comprises a single piece of fabric attached to the support structure.

14. The antenna enclosure of claim 1, wherein the flexible fabric comprises a plurality of pieces of fabric attached to the support structure.

15. The antenna enclosure of claim 1, wherein the flexible fabric comprises an access element for access to the concealed antenna elements and support structure on the interior of the fabric cover.

16. The antenna enclosure of claim 1, wherein the support structure and flexible fabric shell form a tower or rooftop structure.

17. An antenna enclosure comprising:
a support structure including framing elements;
at least one antenna connected to the framing elements of the support structure;
a shell made from a flexible fabric, said flexible fabric material being substantially transparent to electromagnetic waves and having a surface adapted to conceal the support structure and antenna; and
base elements for attaching the support structure and shell to an existing structure or the ground;
whereby said antenna is enclosed by said shell.

18. The antenna enclosure of claim 17, wherein the framing elements include horizontal and vertical framing elements connected together to form a support structure with an interior space.

19. The antenna enclosure of claim 18, wherein the at least one antenna is positioned within the interior space.

20. The antenna enclosure of claim 17, wherein said shell on partially encloses said support structure, and wherein said antenna is enclosed by the partial enclosure of the support structure.

21. The antenna enclosure of claim 17, further comprising cutouts in the flexible fabric shell for display of design items included in the support structure.

22. The antenna enclosure of claim 21, wherein the design items may be selected from the group comprising clocks, lights, signs, or advertisements.
